(19) United States
(12) Patent Application Publication
(10) Pub. No.: US 2016/0332179 A1
(43) Pub. Date: Nov. 17, 2016

(54) TRIGGER-TYPE SPRAYER

(71) Applicant: CANYON CORPORATION, Sanyo Onoda-shi (JP)

(72) Inventor: Tetsuya TADA, Tokyo (JP)

(21) Appl. No.: 15/112,592

(22) PCT Filed: Dec. 29, 2014
(86) PCT No.: PCT/JP2014/006519

§ 371 Date: Jul. 19, 2016

(30) Foreign Application Priority Data
Jan. 22, 2014 (JP) 2014-009919

(51) Int. Cl. B05B 11/00

(52) U.S. Cl. CPC B05B 11/3011; B05B 11/3059

(57) ABSTRACT

A trigger-type sprayer with excellent usability is provided capable of locking rotation of a nozzle part without using a separate component so as not to cause a nozzle orifice to be inadvertently opened. A trigger-type sprayer A of the present invention moves a piston part 3 by pulling and rotating a trigger part to compress liquid in a cylinder part and cause the liquid to be injected from a nozzle part 1 communicating with the cylinder part, and the trigger-type sprayer A includes a lock function of preventing rotation of the nozzle part between the nozzle part 1 and the trigger part 5.

### TECHNICAL FIELD

The present invention relates to a trigger-type sprayer and, in more detail, to a trigger-type sprayer having a lock function to prevent inadvertent rotation of a nozzle part.

### BACKGROUND ART

As a device for spraying liquid accommodated in a container onto a desired position, a trigger-type sprayer has been conventionally known.

This trigger-type sprayer is a device which causes liquid to be injected by rotating a trigger and using a change in pressure due to compression and depression of an internal pump.

In this case, as a structure of a nozzle part, a nozzle orifice is opened by rotation for injecting, and the nozzle orifice is closed by rotation when not in use.

As such, since the nozzle part is rotated to open and close the nozzle orifice in the trigger-type sprayer, a situation may occur such that a child or others inadvertently rotates the nozzle part to open the nozzle orifice and pulls a trigger part to abruptly inject liquid.

To avoid this situation, a trigger-type sprayer including a function of locking rotation of the nozzle part has been developed.

One has a so-called child-resistant function, and is considered useful as a trigger-type sprayer which ensures safety.

As a trigger-type sprayer including this child-resistant function, for example, a mechanism of locking by the nozzle part itself has been provided (refer to PTL 1).

However, this has a disadvantage of making the inner structure of the nozzle part complex.

On the other hand, one using an independent fixture separate from the nozzle part has been provided (refer to PTL 2).

In this mechanism, an operation lever as an independent component is interposed between the nozzle part and the trigger part, and the trigger cannot be operated at an injection stop position.

That is, a hook part as a part of the operation lever goes round to the back of the trigger to be at the injection stop position, thereby inhibiting operation of the trigger.

However, a nozzle fixture as a separate component has to be prepared and, accordingly, the number of components and the number of assembling steps are increased to cause an overload.

Also, since the operation lever may be caught by a user's finger during operation, usability is not necessarily satisfactory.

Therefore, it has been desired that rotation of the nozzle part can be inhibited without using a separate component to cause an injection stop state.

### CITATION LIST

### Patent Literatures

PTL 1: Japanese Patent Application Laid-Open No. 2009-6288

PTL 2: Japanese Patent Application Laid-Open No. 2009-160573

### SUMMARY OF INVENTION

### Technical Problem

The present invention has been made in view of the above circumstances, and has an object of providing a trigger-type sprayer with excellent usability capable of locking rotation of the nozzle part without using a separate component so as not to cause a nozzle orifice to be inadvertently opened.

### Solution to Problems

From diligent studies to solve the above problems, the inventor has found that the above problems can be solved by adding a contrivance to at least a side surface of the nozzle part, and has completed the present invention.

That is, the present invention resides in (1) a trigger-type sprayer A in which a piston part 3 is moved by pulling and rotating a trigger part to compress liquid in a cylinder part and cause the liquid to be injected from a nozzle part 1 communicating with the cylinder part, the trigger-type sprayer A including a lock function of preventing rotation of the nozzle part between the nozzle part 1 and the trigger part 5.

Also, the present invention resides in (2) the trigger-type sprayer A according to the above (1), wherein the trigger part is provided with a receiving part 51, the nozzle part 1 is provided with a lug part 11 having a projection, and the projection can fit in the receiving part 51.

Also, the present invention resides in (3) the trigger-type sprayer A according to the above (2), wherein the lug part 11 can be pressed down via a hinge part by forming a slit S in a part of the nozzle part 1.

Also, the present invention resides in (4) the trigger-type sprayer A according to the above (2), wherein the nozzle part 1 is a quadangular cylinder and has opposing surfaces each provided with the receiving part 51.

Also, the present invention resides in (5) a trigger-type sprayer A including a nozzle part 1, a nozzle base part 2 attached to the nozzle part 1, a piston part 3 attached to the nozzle base part 2, a cylinder part which accommodates the piston part 3, a body part 4 integrated with the cylinder part, a cover part attached to the body part 4, and a trigger part 5 pivotally attached to the body part 4.

Also, the present invention resides in (6) the trigger-type sprayer A, wherein the trigger part 5 and the nozzle base part 2 are integrated via an action coupling part 21.

Note that a structure obtained by combining the above aspects of the invention as appropriate can be adopted as long as the structure is in line with the object of the present invention.

### Advantageous Effects of Invention

In the trigger-type sprayer A in which the piston part 3 is moved by pulling and rotating the trigger part 5 to compress liquid in the cylinder part and cause the liquid to be injected from the nozzle part 1 communicating with the cylinder part, the sprayer includes a lock function of preventing rotation of the nozzle part between the nozzle part 1 and the trigger part. This can prevent a child or others from inadvertently rotating the nozzle part 1 to cause an injectable nozzle-orifice open state.

Also, since two-step operation is required for injection, safety is provided.

Since a lock function works between the nozzle part 1 and the trigger part 5, application is possible even if the body part 4 is not at a position close to the nozzle part 1.

Unlike the conventional technology, a separate component is not used for locking and unlocking. Therefore, the number of components is small and assembling is advantageously performed.

The trigger part 5 is provided with the receiving part 51, the nozzle part 1 is provided with the lug part 11 having the projection 11C, and the projection 11C can fit in the receiving part 51. Therefore, locking is reliably performed therebetween, and this is simple as a lock structure.

With the lug part 11 forming the slit S in a part of the nozzle part 1, the lug part 11 can be easily pressed down with a fingertip via the hinge part 11A.

The nozzle part 1 is a quadangular cylinder and has opposing surfaces each provided with the receiving part 51. Therefore, with rotation of the nozzle part 1 by 90 degrees, switching is made between a nozzle-orifice open state and a nozzle-orifice close state.

Since the trigger-type sprayer A includes the nozzle part 1, the nozzle base part 2 attached to the nozzle part 1, the piston part 3 attached to the nozzle base part 2, the cylinder part 41 which accommodates the piston part 3, the body part 4 integrated with the cylinder part 41, the cover part 6 attached to the body part 4, and the trigger part 5 pivotally attached to the body part 4, the structure is simple as the trigger-type sprayer A.

Since the trigger part 5 and the nozzle base part 2 are integrated via the action coupling part 21, this action coupling part 21 is deformed to cause the motion of the trigger part 5 to be smoothly and efficiently transmitted as a linear motion of the piston part 3.

Since the trigger part 5 and the nozzle base part 2 are integrated, positioning at the time of assembling is not required.

Also, the number of components is small, and assembling is easy.

### BRIEF DESCRIPTION OF DRAWINGS

FIG. 1 is a perspective view depicting one embodiment of a trigger-type sprayer according to the present invention.

FIG. 2 is a partial sectional view depicting a state before a trigger part of the trigger-type sprayer according to the present embodiment is pulled.

FIG. 3 is a partial sectional view depicting a state after the trigger part of the trigger-type sprayer according to the present embodiment is pulled.

FIG. 4 is a diagram depicting a nozzle part for describing a lock function in the present embodiment.

FIG. 5 is a diagram depicting a trigger part for describing the lock function in the present embodiment.

FIG. 6 is a diagram describing operation for unlocking between the nozzle part and the trigger part of the present embodiment, FIG. 6(A) depicting a lock state and FIG. 6(B) depicting an unlock state, each depicting that an upper portion is a side view and a lower portion is a partial sectional view (K-K, O-O).

FIG. 7 is a diagram describing operation for locking between the nozzle part and the trigger part of the present embodiment, FIG. 7(A) depicting a nozzle open state and FIG. 7(B) depicting an overriding state, each depicting that an upper portion is a side view and a lower portion is a partial sectional view (I-I, J-J).

FIG. 8 is a front view depicting a state in which the trigger part and a nozzle base part are integrated via an action coupling part.

FIG. 9 is a partial sectional view depicting the state in which the trigger part and the nozzle base part are integrated via the action coupling part.

### DESCRIPTION OF EMBODIMENTS

In the following, a suitable embodiment of the present invention is described in detail, with reference to the drawings as required.

Note that identical components are provided with a same reference character and redundant description is omitted.

Also, a positional relation, such as upper, lower, left, and right, are based on a positional relation depicted in the drawings unless otherwise specified.

Furthermore, the scaling ratio of the drawings is not restricted to be the one depicted in the drawings.

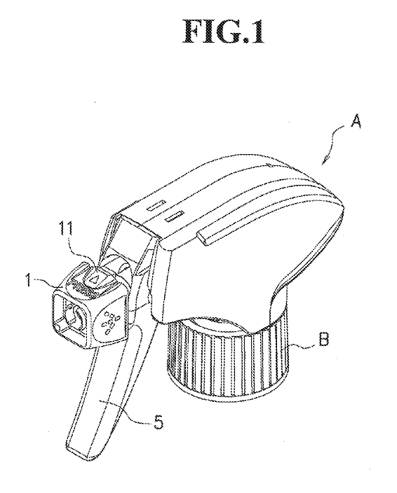

FIG. 1 is a perspective view depicting one embodiment of a trigger-type sprayer A according to the present invention.

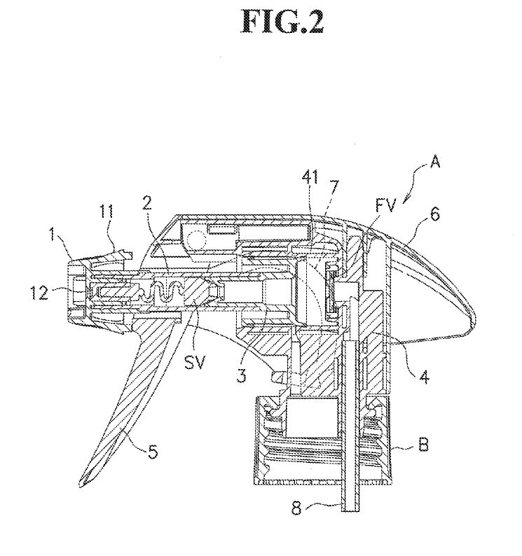

FIG. 2 is a partial sectional view depicting a state before a trigger of the trigger-type sprayer A according to the present embodiment is pulled.

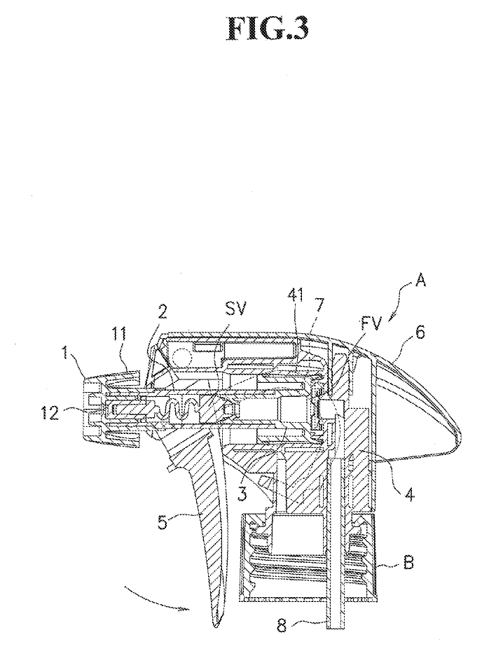

FIG. 3 is a partial sectional view depicting a state after the trigger of the trigger-type sprayer A according to the present embodiment is pulled.

As depicted in the drawings, in the trigger-type sprayer A of the present invention, by pulling and rotating a trigger part 5, a piston part 3 is moved to compress liquid in a cylinder part to cause the liquid to be injected from a nozzle part 1 communicating with the cylinder part 41.

Moreover, the sprayer has a child-resistant function to ensure safety, and therefore is quite useful.

The nozzle part 1 is rotatably attached to a nozzle base part 2. By rotating the nozzle part 1, a passage formed between the nozzle part 1 and the nozzle base part 2 is partially opened or closed to open/close a nozzle orifice 12.

As will be described further below, when the nozzle part 1 is rotated by 90 degrees from a nozzle orifice close state, the state becomes a nozzle orifice open state and, when further rotated by 90 degrees, the state returns to an original nozzle orifice close state.

Normally, in the trigger-type sprayer A, the state is preferably always a nozzle orifice close state when not in use. However, for example, a child or others may inadvertently rotate the nozzle part 1 during playing to cause a nozzle orifice open state.

Thus, liquid may be abruptly leaked to the outside. Furthermore, in this state, when the trigger part 5 is pulled and rotated, the liquid is injected.

To avoid this situation, in the present invention, a lock function is provided to prevent rotation of the nozzle part between the nozzle part 1 and the trigger part so as not to inadvertently rotate the nozzle part 1.

Unless two-step operation as a unique lock function acting between the nozzle part 1 and the trigger part 5 is performed, the state does not become a nozzle orifice open state.

That is, a safe child-resistant function is provided.

This point is a main feature of the present invention.

Next, the lock function is described below in more detail.

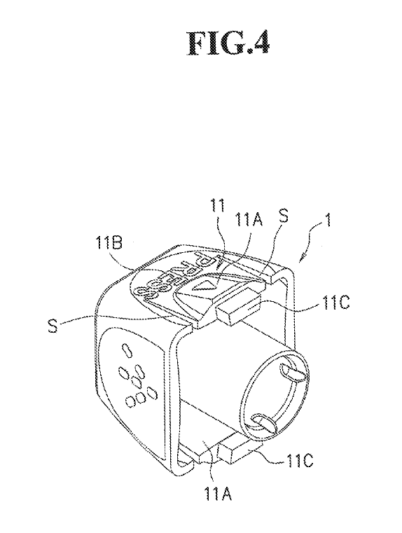

FIG. 4 is a diagram depicting the nozzle part 1 for describing the lock function in the present embodiment.

The nozzle part 1 is a quadangular cylinder formed to have a rectangular section, has four upper, lower, left, and right side surfaces, and has opposing surfaces (upper and lower surface in the drawing) each provided with a lug part 11.

On both sides of this lug part 11, slits S are formed to be coupled to a nozzle part main body via a hinge part 11B as a base part.

With the slits S on both sides, it is possible to elastically press downward with respect to the nozzle part main body by taking the hinge part 11B as a starting point.

Also, an upper surface of the lug part 11 is partially tilted forward to form an inclined surface 11A, and has a projection 11C rearward (in a direction opposite to an injecting direction).

By adding a sign such as, for example, a triangle, to this inclined surface 11A, it is easy to visually recognize a position of the lug part 11 to be pressed.

Since the inclined surface 11A of the lug part 11 is tilted forward, pressing-down operation with a fingertip can be performed very easily.

When pressed, the inclined surface 11A of the lug part 11 elastically moves downward. Therefore, with this action, the nozzle part 1 can lock and unlock the trigger part 5.

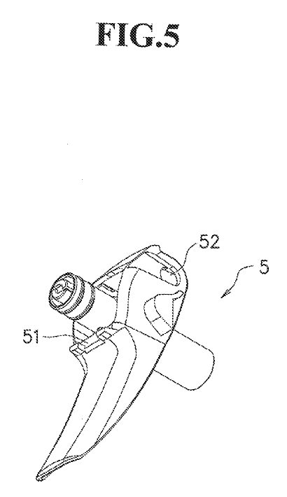

FIG. 5 is a diagram depicting the trigger part 5 for describing the lock function in the present embodiment.

In an upper front portion of the trigger part 5, a receiving part 51 for the projection 11C of the lug part 11 to fit in is formed.

The receiving part 51 is formed of two protrusions on both sides and a space therebetween and is formed in a recessed shape. As will be described further below, the projection 11C of the lug part 11 fits in this space in the receiving part 51.

Next, lock/unlock operation is described.

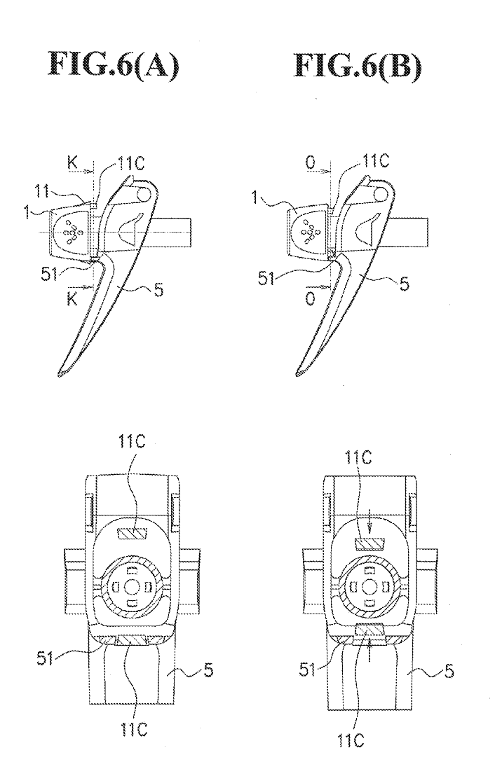

FIG. 6(A) and FIG. 6(B) are diagrams describing operation for unlocking between the nozzle part 1 and the trigger part of the present embodiment, FIG. 6(A) depicting a lock state and FIG. 6(B) depicting an unlock state, each depicting that an upper portion is a side view and a lower portion is a partial sectional view (K-K, O-O).

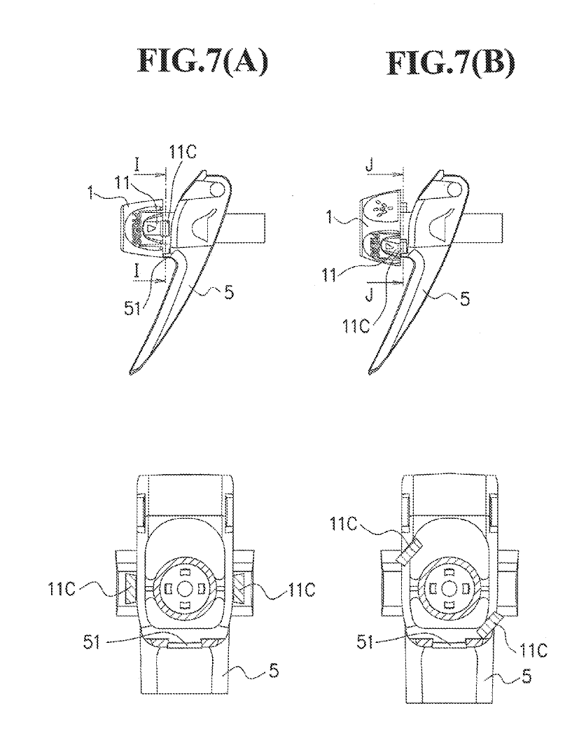

FIG. 7(A) and FIG. 7(B) are diagrams describing operation for locking between the nozzle part 1 and the trigger part of the present embodiment, FIG. 7(A) depicting a nozzle open state and FIG. 7(B) depicting an overriding state, each depicting that an upper portion is a side view and a lower portion is a partial sectional view (I-I, J-J).

First, the nozzle part 1 is assumed to be in a nozzle orifice close state, that is, in a disuse state, as depicted in FIG. 6(A).

At this moment, the projection 11C of the lug part 11 fits in the receiving part 51 of the trigger part 5, and the state is a lock state.

In this state, even if the nozzle part 1 is tried to be forcibly rotated, it is locked and does not move any longer.

For use, the nozzle part 1 has to be in a nozzle orifice open state.

To do this, the nozzle part 1 is pinched by a finger, and the lug part 11 is pressed down by the fingertip (vertical direction in FIG. 6).

Then, the projection 11C of the lug part 11 is released from a state of fitting in the receiving part 51 of the trigger part 5 (lock state), and once becomes an unlock state as depicted in FIG. 6(B).

In this manner, when the state becomes an unlock state, the nozzle part 1 is rotated for rotation by 90 degrees, which causes a nozzle orifice open state as depicted in FIG. 7(A).

In this state, it is possible to pull the trigger part to inject liquid from the nozzle orifice 12.

At the end of use, next, when the nozzle part 1 is pinched by a finger to be rotated for rotation from the nozzle orifice 12 open state by 90 degrees, the state returns to the original nozzle orifice close state as depicted in FIG. 6(A).

Here, when returning to the nozzle orifice close state, the projection 11C at the back of the lug part 11 overrides the receiving part 51 (in detail, the projection of the receiving part 51) of the trigger part 5 to move and fit in the receiving part 51 (in detail, a space in the receiving part 51) as depicted in FIG. 7(B).

For the projection 11C of the lug part 11 to override the receiving part 51 in a manner as described above, a strong force is applied accordingly. As a matter of course, the lug part 11 may be pressed down by a fingertip, and the finger may be released when the projection 11C of the nozzle part 1 matches the receiving part 51 of the trigger part 5 to cause the projection 11C to fit in the receiving part 51.

Once the projection 11C of the lug part 11 fits in the receiving part 51 of the trigger part 5, the nozzle part 1 cannot move any longer even if tried to be rotated in any direction.

With this, a lock state is established between the nozzle part 1 and the trigger part 5, and the nozzle orifice close state is reliably kept.

Thereafter, to cause a nozzle orifice open state again, the lug part 11 is pressed down, and the above is repeated.

As described above, to change a nozzle orifice close state to a nozzle orifice open state, operation (first operation) of pressing down the lug part 11 to change a lock state to an unlock state is first performed, and then operation (second operation) of rotating the nozzle part 1 to cause a nozzle orifice open state is performed.

In detail, in sequence, nozzle orifice close state (lock state)→unlock state (first operation)→90-degree rotation→nozzle orifice open state (second operation)→pulling the trigger part→liquid injection→90-degree rotation→nozzle orifice close state.

In this manner, since two actions, that is, the first operation and the second operation, are required, it is possible to avoid a situation in which a nozzle orifice open state is inadvertently caused and a child or others erroneously injects liquid.

With the child-resistant function capable of ensuring safety with a simple structure as described above, the trigger-type sprayer A of the present invention can be used safely by all people including children irrespective of gender or age, and is also excellent in operability.

Next, a specific example of the trigger-type sprayer A including the child-resistant function as described above is described.

The trigger-type sprayer A of the present invention includes the nozzle part 1, the nozzle base part 2, the piston part 3, the body part 4 integrated with the cylinder part 41, the trigger part 5, and the cover part 6.

Also, between the trigger part and the body part 4, a spring body 7 for pressing the trigger part is provided.

Also, to the body part 4, an F valve FV is attached. To a lower portion of the body part 4, an engaging part with respect to a cap B is provided.

Therefore, the body part 4 is attached to a container not depicted in the drawings as being engaged with the cap B and, by using the function of the trigger-type sprayer A, injects liquid contained in the container from the nozzle orifice 12.

Here, to the nozzle part 1, the nozzle base part 2 is attached by fitting therein. Also, to the nozzle base part 2, the piston part 3 is attached by fitting therein.

In this case, an S valve SV is disposed between the nozzle base part 2 and the piston part 3.

The cylinder part 41 is integrally formed with the body part 4, that is, the body part 4 partially becomes the cylinder part 41.

In this cylinder part 41, the piston part 3 is accommodated. The piston part 3 slides inside the cylinder part.

On the other hand, the trigger part 5 and the nozzle base part 2 are integrated via an action coupling part 21.

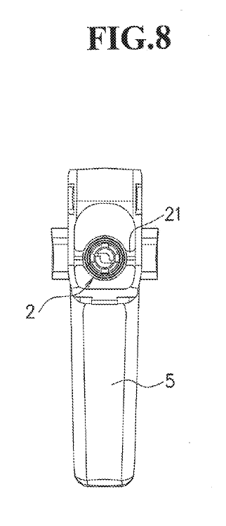

FIG. 8 is a front view depicting a state in which the trigger part and the nozzle base part 2 are integrated via the action coupling part 21.

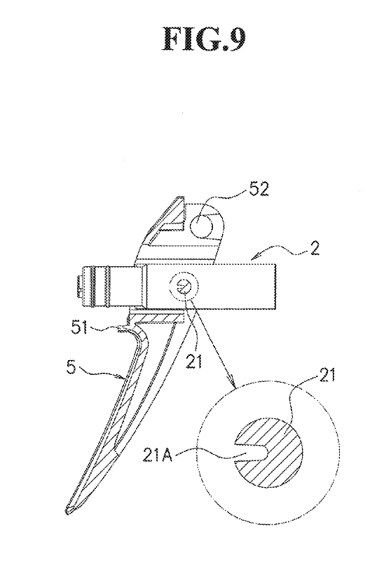

FIG. 9 is a partial sectional view depicting the state in which the trigger part 5 and the nozzle base part 2 are integrated via the action coupling part 21.

This action coupling part 21 is in a columnar shape, projects outward from a side surface of the nozzle base part 2 to couple to the trigger part 5.

When the trigger part 5 is rotated, this action coupling part 21 is deformed by twist or the like to cause the motion of the trigger part 5 to be smoothly and efficiently transmitted as a linear motion of the piston part 3 via the nozzle base part 2.

To make this twist easy, the action coupling part 21 is preferably provided with a V-shaped lateral groove 21A.

Also, since the trigger part 5 and the nozzle base part 2 are integrated, the number of components is small, and assembling is easy.

Also, positioning of both at the time of assembling is not required.

On the other hand, near an upper end of the trigger part 5, a through hole 52 is formed. In the body part 4, a support shaft not depicted projects to both sides.

Therefore, by fitting the support shaft of the body part 4 in the through hole 52 of the trigger part 5, the trigger part 5 is pivotally attached to the body part 4, and can rotate, with the support shaft as a supporting point.

In use, the operation as described above from a nozzle close state is performed twice to open the nozzle orifice, and then the trigger part 5 is pulled and rotated. With this, it is possible to move the piston part 3 to compress the liquid in the cylinder part and cause the liquid to be injected from the nozzle orifice 12 communicating with the cylinder part 41.

The motion of the trigger part 5 can also be smoothly made.

While the embodiment of the present invention has been described in the foregoing, the present invention is not restricted to the above-described embodiment.

While the lug part 11 is provided to each of the two opposing surfaces of the rectangular nozzle part 1 in the trigger-type sprayer A according to the present embodiment, the lug part may be provided to one surface.

In this case, rotation by 90 degrees from a lock state causes an unlock state, further rotation by 90 degrees causes an unlock state, still further rotation by 90 degrees also causes an unlock state, and yet still further rotation by 90 degrees causes a lock state herein.

That is, it is not until rotation by 360 degrees from an initial lock state that the state becomes the original lock state again.

Also, a receiving part provided in place of the projection 11C of the lug part 11 and a projection provided in place of the other receiving part 51 of the trigger part 5 may fit together.

Also, fine asperities for non-slip may be provided to the inclined surface 11A of the lug part 11.

### INDUSTRIAL APPLICABILITY

In the trigger-type sprayer A, the piston part 3 is moved by pulling and rotating the trigger part to compress liquid in the cylinder part and cause the liquid to be injected from the nozzle part 1 communicating with the cylinder part 41, and the trigger-type sprayer A includes the lock function of preventing rotation of the nozzle part between the nozzle part 1 and the trigger part. Therefore, a child or others is prevented from inadvertently rotating the nozzle part 1 for injection.

Also, since two-step operation causes a nozzle open state, a high degree of safety is provided.

Since lock/unlock switching operation is performed between the nozzle part 1 and the trigger part 5, even a structure in which the body part 4 is not at a position close to the nozzle part 1 can be applied.

Unlike the conventional technology, a separate component is not used between locking and unlocking. Therefore, assembling with a small number of components is advantageous.

### REFERENCE SIGNS LIST

1 . . . nozzle part
11 . . . lug part
11A . . . inclined surface
11B . . . hinge part
11C . . . projection
12 . . . nozzle orifice
2 . . . nozzle base part
21 . . . action coupling part
21A . . . V-shaped lateral groove
3 . . . piston part
4 . . . body part
41 . . . cylinder part
5 . . . trigger part
51 . . . receiving part
52 . . . through hole
6 . . . cover part
7 . . . spring body
8 . . . tube
A . . . trigger-type sprayer
B . . . cap
FV . . . F valve
SV . . . S valve
S . . . slit

1. A trigger-type sprayer in which a piston part is moved by pulling and rotating a trigger part to compress liquid in a cylinder part and cause the liquid to be injected from a nozzle part communicating with the cylinder part, the trigger-type sprayer comprising:
a lock function of preventing rotation of the nozzle part between the nozzle part and the trigger part.

2. The trigger-type sprayer according to claim 1, wherein
the trigger part is provided with a receiving part, the nozzle part is provided with a lug part having a projection, and the projection can fit in the receiving part.

3. The trigger-type sprayer according to claim 2, wherein
the lug part can be pressed down via a hinge part by forming a slit in a part of the nozzle part.

4. The trigger-type sprayer according to claim 2, wherein
the nozzle part is a quadangular cylinder and has opposing surfaces each provided with the receiving part.

5. A trigger-type sprayer comprising a nozzle part, a nozzle base part attached to the nozzle part, a piston part attached to the nozzle base part, a cylinder part which accommodates the piston part, a body part integrated with the cylinder part, a cover part attached to the body part, and a trigger part pivotally attached to the body part.

6. The trigger-type sprayer according to claim 5, wherein
the trigger part and the nozzle base part are integrated via an action coupling part.
